(19) United States
(12) Patent Application Publication
(10) Pub. No.: US 2012/0147042 A1
(43) Pub. Date: Jun. 14, 2012

(54) ELECTRONIC PUBLICATION VIEWER, METHOD FOR VIEWING ELECTRONIC PUBLICATION, PROGRAM, AND INTEGRATED CIRCUIT

(76) Inventors: Yuki Shinomoto, Osaka (JP); Hidehiko Shin, Osaka (JP); Tomoko Katayama, Osaka (JP); Nobuki Tominaga, Tokyo (JP)

(21) Appl. No.: 13/391,828

(22) PCT Filed: Jun. 21, 2011
(86) PCT No.: PCT/JP2011/003513

§ 371 Date: Feb. 23, 2012

(30) Foreign Application Priority Data
Jun. 24, 2010 (JP) 2010-144041

(51) Int. Cl. G09G 5/377

(52) U.S. Cl. 345/633

(57) ABSTRACT

An electronic publication viewer (1000) includes a display target specifying unit (1100) that specifies a display target page and the position and size of the display target region, a page structure data obtaining unit (1200) that obtains page structure data corresponding to the display target page, a rendering unit (1300) that generates the display image data corresponding to the position and size of the display target region, a display image data caching unit (1400) that caches the display image data, and a display control unit (1500) that causes the display image data obtained from the rendering unit (1300) or the display image data caching unit (1400) in a position of a display unit superimposed on the display target region.

### TECHNICAL FIELD

The present invention relates to a technique for electronic publication viewers for viewing electronic publications, and particularly relates to a technique for electronic publication viewers in which a user can feel the same sense of operation as that when the user reads paper publications.

### BACKGROUND ART

Electronic publication viewers for displaying a content of an electronic publication on a display in personal computers (PC), mobile phones, or personal digital assistants (PDA) including a touch screen are known in the related art. Moreover, recently, using electronic paper, electronic publication viewers having fineness and reflectance close to paper have been spread.

In the viewers above, usually, the user operates the viewer using a keyboard, a mouse, a touch screen, or the like. For this reason, the sense of operation and feeling of the paper book familiar to the user cannot be provided.

Moreover, in order to provide the sense of operation and feeling of the paper book to the user, a technique of superimposing the content of an electronic book on a physical book within sight of the user using a head mounted display (HMD) is known (for example, see PTL 1).

In the electronic publication viewer in PTL 1, a marker for specifying a page of the electronic publication and a position within the page is printed in each page of the paper book. Using a head mounted display with a camera, according to the information obtained from the camera, the electronic publication viewer recognizes which part of the page the user sees, and performs a processing such that the part of the page seen by the user is displayed on the head mounted display. Further, when the user turns the page of the paper book, the page of the electronic publication to be displayed on the head mounted display is changed. For this reason, the electronic publication viewer in PTL 1 can provide the sense of operation in the paper book to the user.

Moreover, recently, electronic publication viewers having a function to download electronic publications from the Internet have been increased. In such an electronic publication viewer, the entire electronic publication may be downloaded and displayed, or the page of the electronic publication viewed by the user may be downloaded from the Internet one by one.

In order to reduce the size and cost of the electronic publication viewer, a small volume of a memory is often mounted on the electronic publication viewer. In the electronic publication viewer having a small volume of a memory, the page of the electronic publication is downloaded one by one.

Moreover, usually, a cache technique is known in which the obtained page of the electronic publication is not discarded but stored in a memory. The page stored in the memory can be displayed faster than the page downloaded from the Internet. Accordingly, for example, the user stores the pages before and after the viewed page in the memory. Thereby, the page can be displayed fast when the user switches the page to be viewed.

### CITATION LIST

### Patent Literature

[PTL 1] Japanese Patent No. 3993423

### SUMMARY OF INVENTION

### Technical Problem

In the electronic publication viewer having a small volume of a memory, the amount of the page to be cached in the memory is limited. Moreover, when the electronic publication is downloaded from the Internet, it takes some time to obtain the electronic publication at a low line speed of the Internet.

Under such circumstances, when the user switches the viewed page quickly, the page not existing in the cache is more frequently downloaded via the Internet and displayed, leading to reduction in the speed of displaying the page. In the electronic publication viewer in PTL 1, the same problems occur when the user turns the page in the electronic publication viewer quickly.

Moreover, the electronic publication viewer performs a rendering processing of converting the data on the electronic publication obtained from the Internet to a format in which the data can be displayed in the head mounted display. The rendering processing needs to be performed for every page, and therefore has a large processing load when the page is quickly turned. Accordingly, in the conventional electronic publication viewer, the result of rendering is cached in the memory.

When the user quickly turns the pages in a physical book, the user often bends the book, and turns the pages in the state where only part of the page is seen. In this case, the portion viewed by the user is part of the page but not the entire page. In the conventional electronic publication viewer, however, the entire page rendered is cached in the memory. For this reason, in order to increase the cached pages, the volume of the memory has to be increased.

The present invention has been made in consideration of the problems above, and an object of the present invention is to provide an electronic publication viewer that superimposes and displays a content of an electronic book on a display surface wherein the number of pages to be cached is increased, and the page is displayed at a high speed.

### Solution to Problem

An electronic publication viewer according to one embodiment of the present invention displays each page of an electronic publication on a display surface such that the page of the electronic publication is superimposed on a corresponding page of a book for electronic publication viewing. Specifically, the electronic publication viewer includes: a display target specifying unit configured to specify a display target page including a display target region which is a portion of the page in the book for electronic publication viewing seen through the display surface by a user, and a position and size of the display target region in the display target page; a page structure data obtaining unit configured to obtain page structure data corresponding to the display target page, the page structure, data defining a content of each page in the electronic publication to be displayed; a rendering unit configured to generate display image data corresponding to the position and size of the display target region specified by the display target specifying unit from the page structure data obtained by the page structure data obtaining unit, the display image data being image data to be displayed on the display surface; a display image data caching unit configured to cache the display image data generated by the rendering unit; and a display control unit configured to cause the display image data obtained from the display image data caching unit to be displayed in the position on the display surface superimposed on the display target region when the display image data corresponding to the display target region is cached in the display image data caching unit, and to cause the rendering unit to newly generate the display image data, and the display image data newly generated by the rendering unit to be displayed in the position on the display surface superimposed on the display target region when the display image data corresponding to the display target region is not cached in the display image data caching unit.

According to the configuration above, of the display target page, only the display image data corresponding to a portion actually seen by the user is cached. Accordingly, the number of pages to be cached can be increased without increasing the volume of the memory. As a result, the page is displayed at a higher speed when the user turns the book for electronic publication viewing quickly.

Moreover, the display control unit may extract only a portion corresponding to the display target region from the display image data and cause the portion to be displayed on the display surface, and cache the extracted display image data in the display image data caching unit when the display image data on the display target page cached in the display image data caching unit includes a corresponding display target region.

Further, the display control unit may extract only a portion corresponding to the display target region and cache the extracted display image data in the display image data caching unit with respect to display image data different from the display target page cached in the display image data caching unit.

Moreover, when the display image data cached in the display image data caching unit does not include a portion of the display target region, the display control unit may cause the rendering unit to generate only the display image data which corresponds to the portion of the display target region and is not included in the display image data caching unit, combine the display image data cached in the display image data caching unit with the display image data newly generated by the rendering unit and cause the combined display image data to be displayed on the display surface, and cache the combined display image data in the display image data caching unit.

As in the configuration above, the display image data previously generated is effectively used. Thereby, the time needed for rendering can be significantly reduced. As a result, the page is displayed at a higher speed when the user turns the book for electronic publication viewing quickly.

Further, the electronic publication viewer may include a page structure data caching unit configured to cache the page structure data. The page structure data obtaining unit may obtain the page structure data from the page structure data caching unit when the page structure data corresponding to the display target page is cached in the page structure data caching unit. On the other hand, the page structure data obtaining unit may obtain the page structure data from an external apparatus connected via a communication network, and cache the obtained page structure data in the page structure data caching unit when the page structure data corresponding to the display target page is not cached in the page structure data caching unit.

Moreover, the page structure data obtaining unit may obtain the page structure data on a plurality of pages including the display target page from the external apparatus at the same time, and increase or decrease the number of the pages included in the page structure data to be obtained at the same time according to an area of the display target region specified by the display target specifying unit. For example, the number of the pages included in the page structure data to be obtained at the same time may be reduced when the user views the pages without haste (when the area of the display target region is larger), and the number of the pages included in the page structure data to be obtained at the same time may be increased when the user flips through the pages (when the area of the display target region is small).

Further, the electronic publication viewer may include: a user interaction unit configured to receive an instruction from the user; and a title specifying unit configured to specify title information for indentifying the electronic publication to be displayed for the user among a plurality of the electronic publications, based on the instruction received by the user interaction unit.

As one embodiment, the electronic publication viewer may further include a head mounted display including the display surface to be disposed in a position facing an eye of the user, and an image capturing unit configured to capture the display target region. Based on an image captured by the image capturing unit, the display target specifying unit specifies the display target page including the display target region, and the position and size of the display target region in the display target page.

Further, the electronic publication viewer may include a plurality of pages and a plurality of markers disposed in each of the pages, each of the markers including page information for indentifying the page, and position information indicating a position in the page. The display target specifying unit may specify a display target page including the display target region and the position and size of the display target region in the display target page, based on the page information and the position information of the marker included in the display target region captured by the image capturing unit.

Further, the display target specifying unit may specify an amount of the display target region to be deformed, based on a difference between a position of the marker in the display target page specified by the information indicating the position and an actual position of the marker in the display target page captured by the image capturing unit. The display control unit may deform the display image data based on the amount of the display target region to be deformed specified by the display target specifying unit, and cause the deformed display image data to be displayed on the display surface.

As other example, the book for electronic publication viewing may include the display surface and a control unit configured to switch the display target page to be displayed on the display surface according to an operation by the user. The display target specifying unit may obtain the display target page including the display target region and the position and size of the display target region in the display target page from the control unit to display the display target page.

A method for viewing an electronic publication according to one embodiment of the present invention is a method for viewing an electronic publication wherein each page of the electronic publication is displayed on a display surface such that the page of the electronic publication is superimposed on a corresponding page in a book for electronic publication viewing. Specifically, the method includes: specifying a display target page including a display target region which is a portion of the page in the book for electronic publication viewing seen through the display surface by a user, and a position and size of the display target region in the display target page; obtaining page structure data corresponding to the display target page, the page structure data defining a content of each page in the electronic publication to be displayed; generating display image data corresponding to the position and size of the display target region specified in the specifying from the page structure data obtained in the obtaining, the display image data being image data to be displayed on the display surface; and causing the display image data obtained from a display image data caching unit to be displayed in the position on the display surface superimposed on the display target region when the display image data corresponding to the display target region is cached in the display image data caching unit configured to cache the display image data generated, and causing a rendering unit to newly generate the display image data, and causing the display image data newly generated by the rendering unit to be displayed in the position on the display surface superimposed on the display target region when the display image data corresponding to the display target region is not cached in the display image data caching unit.

A program according to one embodiment of the present invention causes a computer to display each page of an electronic publication on a display surface such that the page of the electronic publication is superimposed on a corresponding page of a book for electronic publication viewing. Specifically, the program causes a computer to execute: specifying a display target page including a display target region which is a portion of the page in the book for electronic publication viewing seen through the display surface by a user, and a position and size of the display target region in the display target page; obtaining page structure data corresponding to the display target page, the page structure data defining a content of each page in the electronic publication to be displayed; generating display image data corresponding to the position and size of the display target region specified in the specifying from the page structure data obtained in the obtaining, the display image data being image data to be displayed on the display surface; and causing the display image data obtained from a display image data caching unit to be displayed in the position on the display surface superimposed on the display target region when the display image data corresponding to the display target region is cached in the display image data caching unit configured to cache the display image data generated, and causing a rendering unit to newly generate the display image data, and causing the display image data newly generated by the rendering unit to be displayed in the position on the display surface superimposed on the display target region when the display image data corresponding to the display target region is not cached in the display image data caching unit.

An integrated circuit according to one embodiment of the present invention displays each page of an electronic publication on a display surface such that the page of the electronic publication is superimposed on a corresponding page in a book for electronic publication viewing. Specifically, the integrated circuit includes: a display target specifying unit configured to specify a display target page including a display target region which is a portion of the page in the book for electronic publication viewing seen through the display surface by a user, and a position and size of the display target region in the display target page; a page structure data obtaining unit configured to obtain page structure data corresponding to the display target page, the page structure data defining a content of each page in the electronic publication to be displayed; a rendering unit configured to generate display image data corresponding to the position and size of the display target region specified by the display target specifying unit from the page structure data obtained by the page structure data obtaining unit, the display image data being image data to be displayed on the display surface, a display image data caching unit configured to cache the display image data generated by the rendering unit; and a display control unit configured to cause the display image data obtained from the display image data caching unit to be displayed in the position on the display surface superimposed on the display target region when the display image data corresponding to the display target region is cached in the display image data caching unit, and to cause the rendering unit to newly generate the display image data, and the display image data newly generated by the rendering unit to be displayed in the position on the display surface superimposed on the display target region when the display image data corresponding to the display target region is not cached in the display image data caching unit.

### Advantageous Effects of Invention

According to the present invention, of the display image data on the page of the electronic publication, only the portion seen by the user is cached. Thereby, the number of pages to be cached can be increased without increasing the volume of the memory. As a result, the page is displayed at a higher speed when the user turns the book for electronic publication viewing quickly.

### BRIEF DESCRIPTION OF DRAWINGS

FIG. 1 is a block diagram of an electronic publication viewer according to one embodiment of the present invention.

FIG. 2 is a drawing for schematically describing an electronic publication viewer according to Embodiment 1 of the present invention.

FIG. 3 is a drawing showing an example of a book for electronic publication viewing.

FIG. 4 is a block diagram of the electronic publication viewer according to Embodiment 1 of the present invention.

FIG. 5 is a drawing showing an example of a camera image captured by a camera.

FIG. 6 is a drawing showing an example in which an electronic publication is displayed so as to be superimposed on the display target region.

FIG. 7 is a flowchart showing a processing of setting a title of an electronic publication.

FIG. 8 is a flowchart showing a whole processing of displaying an electronic publication.

FIG. 9 is a flowchart showing the detail of the processing in Step S2004 in FIG. 8.

FIG. 10 is a flowchart showing the detail of the processing Step S2007 in FIG. 8.

FIG. 11 is a drawing showing an example of marker information obtained from a marker.

FIG. 12 is a drawing showing an example of the marker information output from a marker recognizing unit.

FIG. 13 is a drowsing showing an appearance of a book for electronic publication viewing according to Embodiment 2 of the present invention.

FIG. 14 is a block diagram of a book for electronic publication viewing according to Embodiment 2 of the present invention.

### DESCRIPTION OF EMBODIMENTS

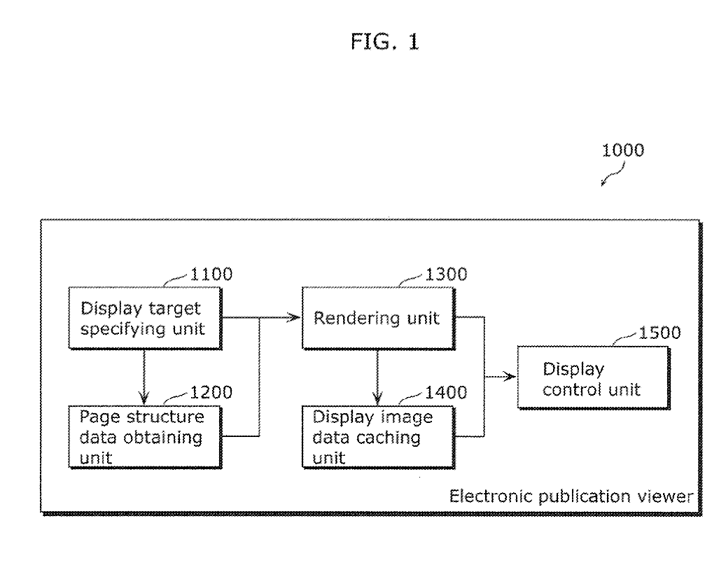

FIG. 1 is a functional block diagram of an electronic publication viewer according to one embodiment of the present invention. An electronic publication viewer 1000 shown in FIG. 1 is an apparatus that displays each page of an electronic publication on a display surface such that the page of the electronic publication is superimposed on a corresponding page of a book for electronic publication viewing. The electronic publication viewer 1000 includes a display target specifying unit 1100, a page structure data obtaining unit 1200, a rendering unit 1300, a display image data caching unit 1400, and a display control unit 1500.

The display target specifying unit 1100 specifies a display target page including a display target region and a position and size of the display target region in the display target page, the display target region being a portion in a page of a book for electronic publication viewing that is seen by a user through a display surface.

The page structure data obtaining unit 1200 obtains page structure data corresponding to the display target page, the page structure data defining a content of each page of the electronic publication to be displayed.

The rendering unit 1300 generates image data displayed on the display surface, i.e., display image data corresponding to the position and size of the display target region specified by the display target specifying unit 1100 from the page structure data obtained by the page structure data obtaining unit 1200.

The display image data caching unit 1400 caches the display image data generated by the rendering unit 1300.

In the case where the display image data corresponding to the display target region is cached by the display image data caching unit 1400, the display control unit 1500 displays the display image data obtained from the display image data caching unit 1400 in a position on the display surface superimposed on the display target region. On the other hand, in the case where the no display image data corresponding to the display target region is cached in the display image data caching unit 1400, the display control unit 1500 causes the rendering unit 1300 to generate new display image data, and causes the display image data newly generated by the rendering unit 1300 to be displayed in a position on the display surface superimposed on the display target region.

Hereinafter, electronic publication viewers according to embodiments of the present invention will be described in detail with reference to the drawings.

### Embodiment 1

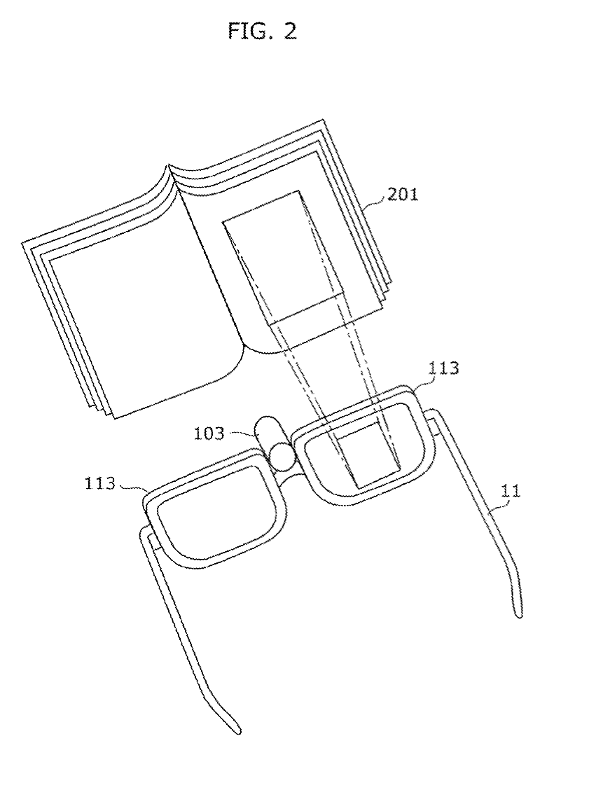

First, with reference to FIG. 2, an electronic publication viewer according to Embodiment 1 of the present invention will be schematically described. In the electronic publication viewer shown in FIG. 2, the user puts on a head mounted display 11. Thereby, each page of the electronic publication is displayed so as to be superimposed on the corresponding page of a book for electronic publication viewing 201 located within the sight of the user.

Specifically, the head mounted display 11 includes a camera 103 and a display unit 113. The head mounted display 11 typically has a shape of a pair of eyeglasses, and is mounted on the front head of the user.

The display unit (display surface) 113 is disposed in a position facing an eye of the user like a lens of the eyeglass, for example. The display unit 113 is composed of a half mirror or a hologram optical element (HOE), for example. For this reason, the user can see the field out of the display unit 113 through the display unit 113 while the user sees the image displayed on the display unit 113. In the example shown in FIG. 2, a display unit 113 for the right eye and that for the left eye are separately provided, but the display unit is not limited to this. One horizontally oblong display surface may be disposed in a position facing the eyes of the user.

A camera (image capturing unit) 103 captures a direction of a line-of-sight of the user. More specifically, the camera 103 captures a display target region, which is a portion in a page of the book for electronic publication viewing 201 that is seen by the user through the display unit 113. In the example shown in FIG. 2, the camera 103 is disposed between the display units 113 for the right eye and for the left eye.

The user puts on the head mounted display 11 having the configuration above. Based on the image captured by the camera 103, the page opened in the book for electronic publication viewing 201 is specified. Then, the page corresponding to the page of the electronic publication is displayed in the display unit 113. Thereby, the user can feel as if the electronic publication is displayed in each page of the book for electronic publication viewing 201.

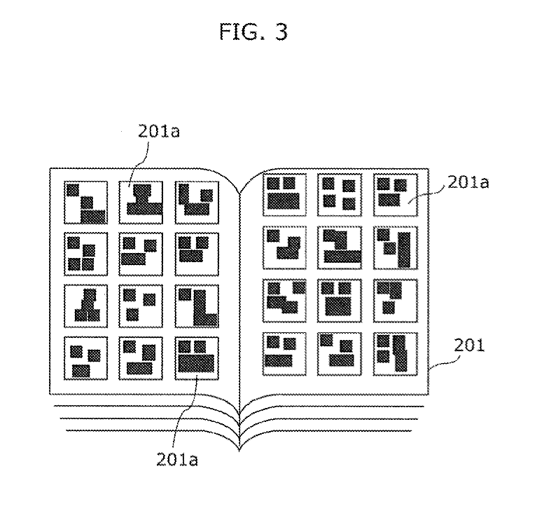

FIG. 3 is a drawing showing an example of the book for electronic publication viewing 201. The book for electronic publication viewing 201 includes a plurality of pages and a marker 201a disposed in each of the pages. The marker 201a holds page information indicating the page number of each page in the book for electronic publication viewing 201, and marker information including position information indicating the position of the page in which the marker 201a is disposed. The marker 201a has a two-dimensional pattern, for example.

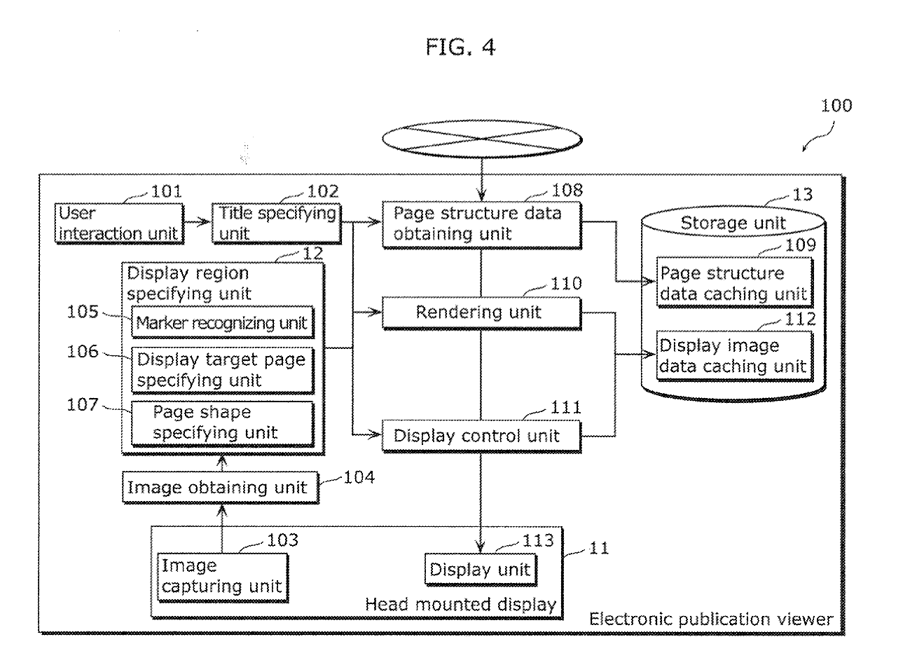

FIG. 4 is a block diagram of an electronic publication viewer 100 according to an embodiment of the present invention. The electronic publication viewer 100 includes the head mounted display 11 including the camera 103 and the display unit 113, a display region specifying unit 12, a storage unit 13, a user interaction unit 101, a title specifying unit 102, an image obtaining unit 104, a page structure data obtaining unit 108, a rendering unit 110, and a display control unit 111.

All or part of the display region specifying unit 12, the storage unit 13, the user interaction unit 101, the title specifying unit 102, the image obtaining unit 104, the page structure data obtaining unit 108, the rendering unit 110, and the display control unit 111 may be incorporated into the head mounted display 11, or may be accommodated in a casing separately from the head mounted display 11 and wire-connected or wirelessly connected to the head mounted display 11.

The user interaction unit 101 receives an operation from the user, and obtains information indicating the tile of the electronic publication to be viewed.

Based on the information indicating the title of the electronic publication obtained by the user interaction unit 101, the title specifying unit 102 specifies title information for identifying the electronic publication to be displayed for the user among a plurality of electronic publications, and provides the title information in response to a request of the display target page specifying unit 106.

The image obtaining unit 104 obtains a camera image captured by the camera 103 from the camera 103, and stores the camera image. The image obtaining unit 104 also provides the obtained camera image in response to a request of a marker recognizing unit 105.

The display region specifying unit 12 includes the marker recognizing unit 105, the display target page specifying unit 106, and a page shape specifying unit 107. The display region specifying unit 12 corresponds to the display target specifying unit 1100 in FIG. 1.

Based on the camera image obtained from the image obtaining unit 104, the marker recognizing unit 105 extracts and stores the marker information held by the marker 201a. The marker recognizing unit 105 also provides the extracted marker information in response to a request of the display target page specifying unit 106 and the page shape specifying unit 107.

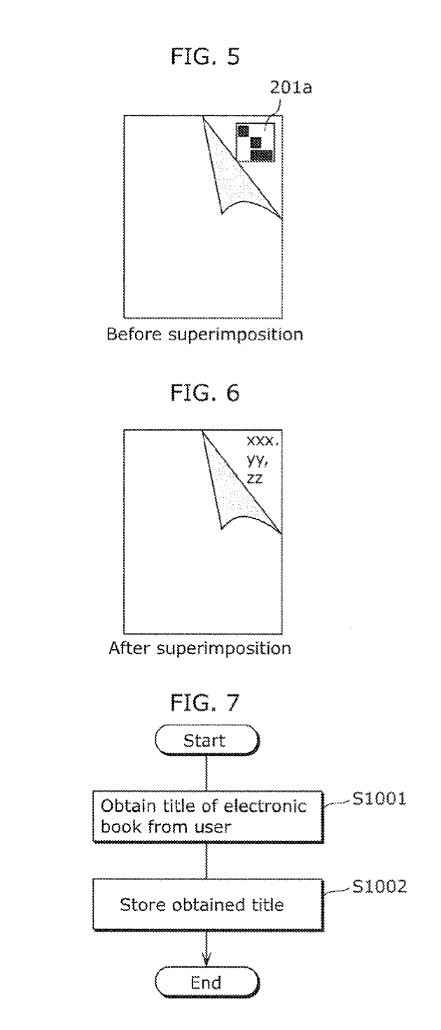

For example, assume that as in FIG. 5, in the camera image obtained from the image obtaining unit 104, the upper right corner of the page is slightly curled up, and only part of the next page is seen. In this case, the marker recognizing unit 105 extracts the page information from the marker 201a of the page only partially seen on the upper right corner. Namely, the region partially seen is the display target region.

While the example shown in FIG. 5 shows the marker 201a given to only the page seen on the upper right corner, the marker is also given to the front page and the rear side of the page (hatched page). The marker recognizing unit 105 performs the processing on these pages.

Based on the marker information obtained from the marker recognizing unit 105, the display target page specifying unit 106 recognizes the page number of the page being viewed, and stores the page number as the page information indicating the display target page. The page information is a positive integer wherein the total page number of the book for electronic publication viewing 201 is the maximum value, for example.

Based on the marker information obtained from the marker recognizing unit 105, the page shape specifying unit 107 generates page shape information indicating the shape of the page, and stores the page shape information. The page shape information includes the information for specifying the position and size of the display target region in the display target page, and the amount of the display target region to be deformed (bent), for example.

The page structure data obtaining unit 108 obtains the title information on the electronic publication from the title specifying unit 102, and obtains the page information from the display target page specifying unit 106 in the display region specifying unit 12. The page structure data obtaining unit 108 obtains the page structure data on the page specified by the page information in the electronic publication specified by the title information, and provides the page structure data to the rendering unit 110. The page structure data obtaining unit 108 corresponds to the page structure data obtaining unit 1200 in FIG. 1.

First, the page structure data obtaining unit 108 checks whether the page structure data exists in a page structure data caching unit 109. When the page structure data exists in the page structure data caching unit 109, the page structure data obtaining unit 108 obtains the page structure data from the page structure data caching unit 109.

On the other hand, when the page structure data does not exist in the page structure data caching unit 109, the page structure data obtaining unit 108 obtains the page data from an external apparatus (a content server or the like) connected via a communication network, for example, and provides the obtained page data to the rendering unit 110 and stores the obtained page structure data in the page structure data caching unit 109.

The page structure data is data that defines a content of the page of the electronic publication to be displayed. The page structure data includes the content such as texts, images, and moving pictures and layout information on the page. The layout information is described by the XML (eXtensible Markup Language) or the HTML (Hyper Text Markup Language), for example.

The layout information describes the link to the content and information on disposition of the content in the page. The text in the content may be embedded in the layout information, or may be provided as a file independent from the layout information.

The rendering unit 110 performs a rendering processing of converting the page structure data obtained by the page structure data obtaining unit 108 to display image data that is a data format for display on the display unit 113. At this time, the rendering unit 110 obtains the page shape information including the information indicating the position and size of the display target region from the page shape specifying unit 107. Based on the obtained page shape information, the rendering unit 110 generates the display image data on only a portion corresponding to the display target region in the display target page. The rendering unit 110 corresponds to the rendering unit 1300 in FIG. 1.

Specifically, when the display image data on the page including the marker 201a shown in FIG. 5 is generated, the rendering unit 110 obtains the page structure data on the entire page from the page structure data obtaining unit 108. Based on the page structure data obtained from the page structure data obtaining unit 108 and the information indicating the position and size of the display target region obtained from the page shape specifying unit 107, the rendering unit 110 generates only the display image data corresponding to the display target region shown in the upper right corner in FIG. 5.

The storage unit 13 includes a page structure data caching unit 109 and a display image data caching unit 112. The specific configuration of the storage unit 13 is not particularly limited, and any storage medium that can store the data such as DRAMs (Dynamic Random Access Memory), SRAMs (Static Random Access Memory), flash memories, or HDDs (Hard Disc Drives) can be used.

The page structure data caching unit 109 temporarily stores the page structure data obtained by the page structure data obtaining unit 108. When the total amount of the stored page structure data exceeds a predetermined reference value, the page structure data caching unit 109 deletes the stored page structure data until the total data amount thereof is reduced to the reference value or less, for example, according to a criterion in which the page structure data is deleted in order of an older data obtaining time (First In First Out).

The display image data caching unit 112 stores the display image data generated by the rendering unit 110 in response to a request of the display control unit 111. When the total amount of the stored display image data exceeds a predetermined reference value, the display image data caching unit 112 deletes the stored display image data until the total data amount thereof is reduced to the reference value or less, for example, according to a criterion in which the page structure data is deleted in order of an older data obtaining time (First In First Out). The display image data caching unit 112 corresponds to the display image data caching unit 1400 in FIG. 1.

The display control unit 111 obtains the title information from the title specifying unit 102, the page information from the display target page specifying unit 106, and the page shape information from the page shape specifying unit 107. The display control unit 111 obtains the display target data on the page from the rendering unit 110 or the display image data caching unit 112. The display control unit 111 corresponds to the display control unit 1500 in FIG. 1.

First, the display control unit 111 checks whether the display image data corresponding to the display target region is cached in the display image data caching unit 112. When the display image data is cached in the display image data caching unit 112, the display control unit 111 obtains the display image data from the display image data caching unit 112.

On the other hand, when no display image data corresponding to the display target region exists in the display image data caching unit 112, the display control unit 111 causes the page structure data obtaining unit 108 to obtain the page structure data and the rendering unit 110 to render the page structure data. Thereby, the display image data corresponding to the display target region is obtained, and stored in the display image data caching unit 112.

The display control unit 111 deforms the obtained display image data according to the amount of the display target region to be deformed included in the page shape information obtained from the page shape specifying unit 107, and instructs the head mounted display 11 to display the deformed display image data.

The head mounted display 11 displays the deformed display image data on the display unit 113 in response to the instruction from the display control unit 111, and presents the display image data to the user. Namely, when the display image data obtained from the display control unit 111 is displayed on the display unit 113 so as to be superimposed on the display target region specified by the marker 201a shown in FIG. 5, the user sees the display image data as shown in FIG. 6.

The configuration of the electronic publication viewer 100 has been described.

### (Flowcharts)

Hereinafter, the processing performed by the electronic publication viewer 100 according to the present embodiment will be described. FIG. 7 is a flowchart showing a processing of setting the title of the electronic publication performed by the electronic publication viewer 100 according to the present embodiment.

In Step S1001, the user interaction unit 101 obtains information indicating the title of the electronic publication entered by the user. For example, first, the user interaction unit 101 displays a list of the titles of the electronic publications that can be viewed on the display unit 113 in the head mounted display 11. Using an input device such as a button, the user determines the title of the electronic publication that the user desires to see in the list of the titles displayed. Alternatively, the user may determine the title using an audio input.

In Step S1002, the user interaction unit 101 transmits information indicating the title obtained in Step S1001 to the title specifying unit 102, and instructs the title specifying unit 102 to store the transmitted information indicating the title. Based on the received information indicating the title from the user interaction unit 101, the title specifying unit 102 specifies the title information, and provides the title information to the page structure data obtaining unit 108, the rendering unit 110, and the display control unit 111 when necessary.

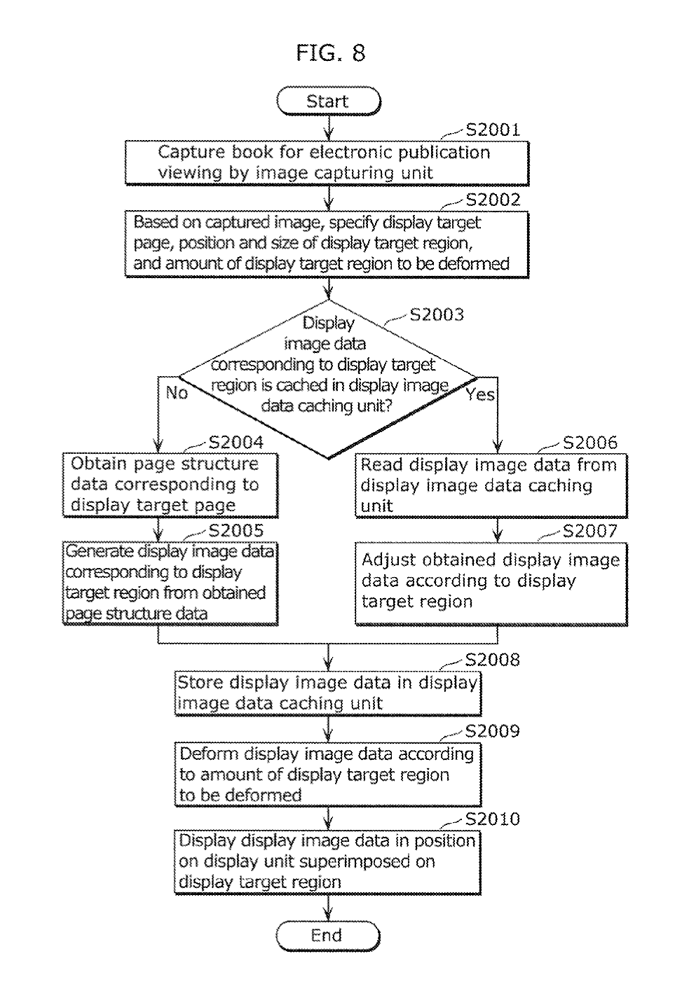

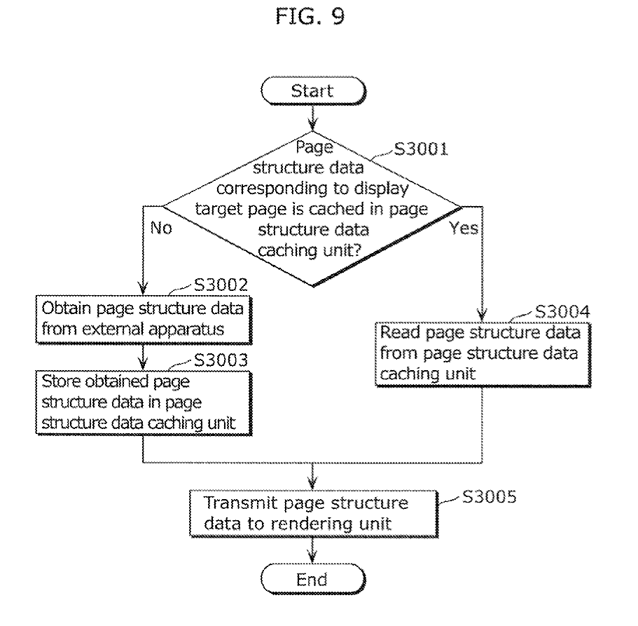

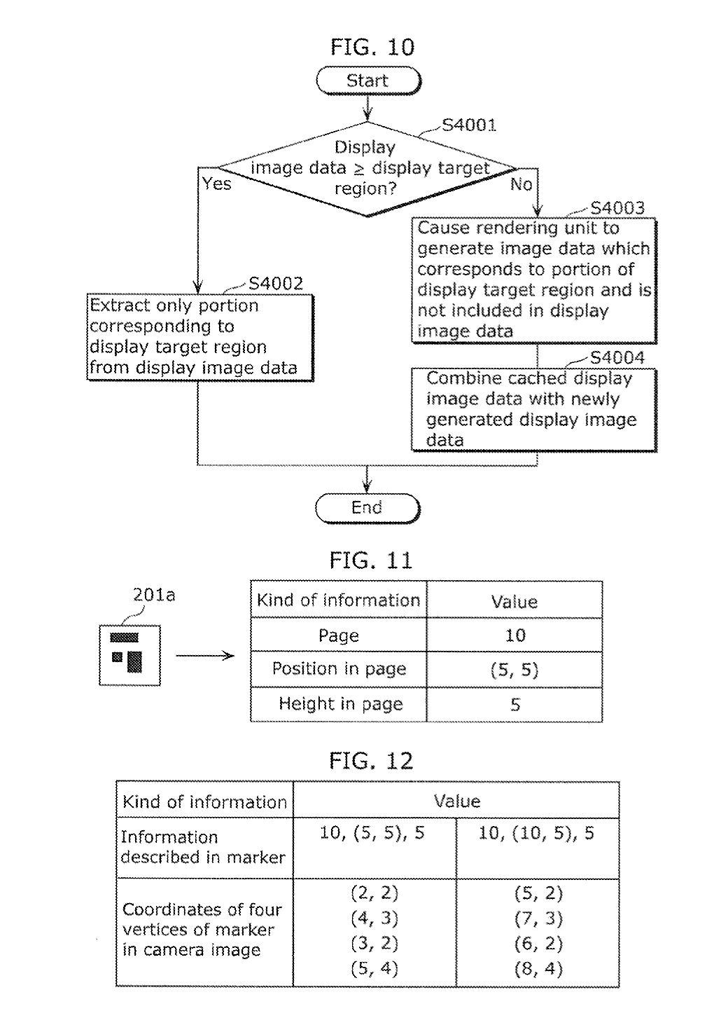

With reference to FIG. 8 to FIG. 12, the processing of displaying the electronic publication performed by the electronic publication viewer 100 according to the present embodiment will be described. FIG. 8 is a flowchart showing the whole displaying processing performed by the electronic publication viewer 100. FIG. 9 is a flowchart showing the detail of the processing in Step S2004 in FIG. 8. FIG. 10 is a flowchart showing the detail of the processing in Step S2007 in FIG. 8. FIG. 11 is a drawing showing an example of the marker information obtained from the marker. FIG. 12 is a drawing showing an example of the marker information output from the marker recognizing unit 105. The processing is repeatedly performed after the processing of setting the title of the electronic publication is completed.

In Step S2001, the camera 103 captures the book for electronic publication viewing 201. Description will be given assuming that the camera image shown in FIG. 5 is captured, and the portion seen in the upper right corner in FIG. 5 is the display target region.

Next, in Step S2002, the image obtaining unit 104 obtains the camera image from the camera 103, and provides the camera image to the display region specifying unit 12. Based on the camera image obtained from the image obtaining unit 104, the display region specifying unit 12 specifies the display target page, the information indicating the position and size of the display target region, and the amount of the display target region to be deformed.

First, the marker recognizing unit 105 obtains the camera image from the image obtaining unit 104. In the marker 201a recognized from the camera image, the marker recognizing unit 105 extracts the marker information described in the marker 201a and the actual position and shape of the marker 201a in the camera image, and provides the marker information and the actual position and shape of the marker 201a to the display target page specifying unit 106 and the page shape specifying unit 107.

FIG. 11 shows the marker information held by the marker 201a in the present embodiment. The marker 201a describes the page, the position of the marker 201a in the page, and the height of the marker. As a method for extracting the information described in the marker 201a, the conventional method as described in PTL 1 can be used, for example.

The page indicates the page number of the book for electronic publication viewing 201 in which the marker 201a is printed. The position in the page indicates the distance in centimeters between the upper left position of the marker 201a and the upper left corner of the page, using the two-dimensional coordinate frame. The height of the marker indicates the longitudinal length of the marker 201a in centimeters. In the present embodiment, because the marker 201a is a square, description of the width of the marker (the length of the marker 201a in the traverse direction) is omitted. In the case where the marker 201a is rectangular, the information on the width needs to be held.

The actual position in the camera image is indicated by the two-dimensional coordinate frame wherein the upper left corner of the camera image is (0,0) and the lower right corner of the camera image is (1024,768), for example, in the case where the camera image has a height of 768 pixels and a width of 1024 pixels. The actual shape of the marker 201a in the camera image is defined by positions of the four vertices of the marker 201a in the camera image. As a method for recognizing the actual position and shape of the marker 201a in the camera image, the conventional method as described in PTL 1 can be used, for example.

The marker information output from the marker recognizing unit 105 is information on all the markers 201a recognized in the page in which the information described in the marker 201a is combined with the information on the actual position and shape of the marker 201a in the camera image, for example, as shown in FIG. 12.

Next, based on the marker information obtained from the marker recognizing unit 105, the display target page specifying unit 106 specifies the display target page including the display target region. The same page information is described in all the markers 201a disposed in the same page. Accordingly, if only one of the markers 201a is recognized, the display target page specifying unit 106 can specify the display target page from the marker information.

Next, based on the marker information obtained from the marker recognizing unit 105, the page shape specifying unit 107 generates the page shape information on the display target page. The page shape information includes the information obtained from the marker recognizing unit 105, i.e., the information on the position and size of the portion of the page serving as the display target (display target region) in the page, and additional information on a portion in which the marker 201a is not recognized, i.e., the portion that is not the display target.

In Step S2003, the display control unit 111 obtains the page information from the display target page specifying unit 106, the title information from the title specifying unit 102, and the page shape information from the page shape specifying unit 107. The display control unit 111 checks whether the display image data corresponding to the display target region specified by the obtained information is cached in the display image data caching unit 112.

When no display image data corresponding to the display target region exists in the display image data caching unit 112 (No in Step S2003), the processing goes to Step S2004.

In Step S2004, based on the title information specified by the title specifying unit 102 and the page information specified by the display target page specifying unit 106, the display control unit 111 causes the page structure data obtaining unit 108 to obtain the page structure data corresponding to the display target page. The specific content of the processing performed by the page structure data obtaining unit 108 will be described later with reference to FIG. 9.

In Step S2005, the display control unit 111 causes the rendering unit 110 to render the page structure data obtained from the page structure data obtaining unit 108 and generate the display image data. Specifically, referring to the page shape information obtained from the page shape specifying unit 107, the rendering unit 110 generates the display image data on only the portion corresponding to the display target region in the display target page, and provides the generated display image data to the display control unit 111.

On the other hand, when the display image data corresponding to the display target region exists in the display image data caching unit 112 (Yes in Step S2003), the processing goes to Step S2006.

In Step S2006, the display control unit 111 obtains the display image data corresponding to the display target region from the display image data caching unit 112. The display image data obtained here may not completely match with the display target region. Namely, the display image data obtained from the display image data caching unit 112 may be a region that is larger than the display target region and includes the entire display target region, or may include only a portion of the display target region. In other words, the “display image data corresponding to the display target region” refers to the display image data including at least a portion of the display target region.

In Step S2007, the display control unit 111 adjusts the display image data obtained from the display image data caching unit 112 according to the display target region. The specific content of the processing will be described later with reference to FIG. 10.

In Step S2008, the display control unit 111 stores the display image data newly generated in Step S2005 or the display image data adjusted in Step S2007 in the display image data caching unit 112 in association with the title information obtained from the title specifying unit 102, the page information obtained from the display target page specifying unit 106, the page shape obtained from the page shape specifying unit 107, and the date and time of storing. Here, when the display image data caching unit 112 cleans up the cache, the cached display image data may be scanned, and a portion in the current page shape that is not the display target may be partially deleted.

When the total amount of the display image data already stored in the display image data caching unit 112 exceeds a predetermined reference value, the display control unit 111 deletes the stored display image data in order of an older date and time of storing until the total data amount is reduced to the reference value or less.

In Step S2009, the display control unit 111 deforms the display image data obtained from the rendering unit 110 or the display image data caching unit 112 according to the amount of the display target region to be deformed included in the page shape information obtained from the page shape specifying unit 107. More specifically, the display image data is deformed into a rectangular shape defined by the four vertices of the marker 201a in the camera image. The display control unit 111 obtains the size of the camera image in advance.

In Step S2010, the display control unit 111 transmits the deformed display image data, and instructs the head mounted display 11 to display the deformed display image data. The head mounted display 11 displays the display image data obtained from the display control unit 111 in the position on the display unit 113 superimposed on the display target region in the book for electronic publication viewing 201.

Next, with reference to FIG. 9, the detail of the processing in Step S2004 will be described. FIG. 9 is a flowchart showing the detail of the processing performed by the page structure data obtaining unit 108 in Step S2004.

In Step S3001, the page structure data obtaining unit 108 checks whether the page structure data corresponding to the title information obtained from the title specifying unit 102 and the page information obtained from the display target page specifying unit 106 are stored in the page structure data caching unit 109. When the page structure data is not stored in the page structure data caching unit 109 (No in Step S3001), the processing goes to Step S3002.

In Step S3002, the page structure data obtaining unit 108 obtains the page structure data corresponding to the display target page from an external apparatus connected via a communication network.

In Step S3003, the page structure data obtaining unit 108 stores the page structure data obtained from the external apparatus in the page structure data caching unit 109 in association with the title information obtained from the title specifying unit 102, the page information obtained from the display target page specifying unit 106, and the date and time of storing. At this time, when the total amount of the page structure data stored in the page structure data caching unit 109 exceeds a predetermined reference value, the page structure data is deleted in order of an older date and time of storing until the total data amount is reduced to the reference value or less.

On the other hand, in Step S3001, when the page structure data is stored in the page structure data caching unit 109 (Yes in Step S3001), the processing goes to Step S3004.

In Step S3004, the page structure data obtaining unit 108 obtains the page structure data corresponding to the display target page from the page structure data caching unit 109.

In Step S3005, the page structure data obtaining unit 108 transmits the page structure data obtained in Step S3002 or Step S3004 to the rendering unit 110.

Further based on the title information obtained from the title specifying unit 102 and the page information obtained from the display target page specifying unit 106, the page structure data obtaining unit 108 may presume the page that the user may read next to the display target page, and obtain the page structure data on the presumed page in advance at the same time when the page structure data corresponding to the display target page is obtained.

At this time, the page structure data obtaining unit 108 may further obtain the information indicating the size (area) of the display target region from the page shape specifying unit 107, and may determine the number of the pages included in the page structure data to be obtained in advance, based on the information. For example, the number of the pages included in the page structure data to be obtained at the same time may be smaller as the area of the display target region is larger; the number of the page structure data to be obtained at the same time may be larger as the area of the display target region is smaller.

Next, with reference to FIG. 10, the detail of the processing in Step S2007 will be described. FIG. 10 is a flowchart showing the detail of the processing in Step S2007 in which the display control unit 111 adjusts the display image data obtained from the display image data caching unit 112 according to the display target region.

In Step S4001, the display control unit 111 compares the information indicating the position and size of the display target region obtained from the page shape specifying unit 107 with the display image data obtained from the display image data caching unit 112. When the obtained display image data includes the entire display target region (Yes in Step S4001), the processing goes to Step S4002.

In Step S4002, the display control unit 111 extracts only the portion corresponding to the display target region in the display target data on the display target page obtained from the display image data caching unit 112.

The display control unit 111 may perform the same processing on not only the display target page but also the display image data on the page other than the display target page stored in the display image data caching unit 112. Namely, the display control unit 111 may edit all the display image data stored in the display image data caching unit 112 according to the position and size of the current display target region, and store the edited display image data again in the display image data caching unit 112. Thereby, a larger amount of the display image data can be cached.

On the other hand, when the obtained display image data does not include the entire display target region, namely, when the obtained display image data does not include a portion of the corresponding display target region (No in Step S4001), the processing goes to Step S4003.

In Step S4003, the display control unit 111 causes the rendering unit 110 to newly render the display image data which corresponds to the portion of the display target region and is not included in the display image data. The content of the processing at this time is the same as those in Step S2004 and Step S2005 in FIG. 8, and the description thereof will be omitted.

In Step S4004, the display control unit 111 combines (synthesizes) the display image data cached in the display image data caching unit 112 with the display image data newly generated by the rendering unit 110 to generate the display image data corresponding to the display target region.

The electronic publication viewer 100 according to the present embodiment recognizes the shape of the page in the book for electronic publication viewing 201, determines the range of the display target in the page of the electronic publication, and controls caching of the display image data as a result of rendering such that only the range of the display target is cached.

Accordingly, according to the control method according to the present embodiment, a larger amount of the display image data can be cached and the page of the electronic publication can be displayed at a higher speed than in the case where the control method according to the present embodiment is not used.

In the electronic publication viewer 100 according to the present embodiment, the two-dimensional marker is used to obtain the page information. The present invention is not limited to this, and the page information printed on the book for electronic publication viewing 201 may be directly recognized. Alternatively, the shape of the book for electronic publication viewing 201 may be directly recognized from the camera image to obtain the page shape information.

While the head mounted display 11 is used in the electronic publication viewer 100 according to the present invention, the electronic publication may be projected on the book for electronic publication viewing 201 using a projector or the like.

Moreover, in addition to the book for electronic publication viewing, the present invention can also be used in the case where the electronic publication is superimposed and displayed on an object whose shape can be changed.

### Embodiment 2

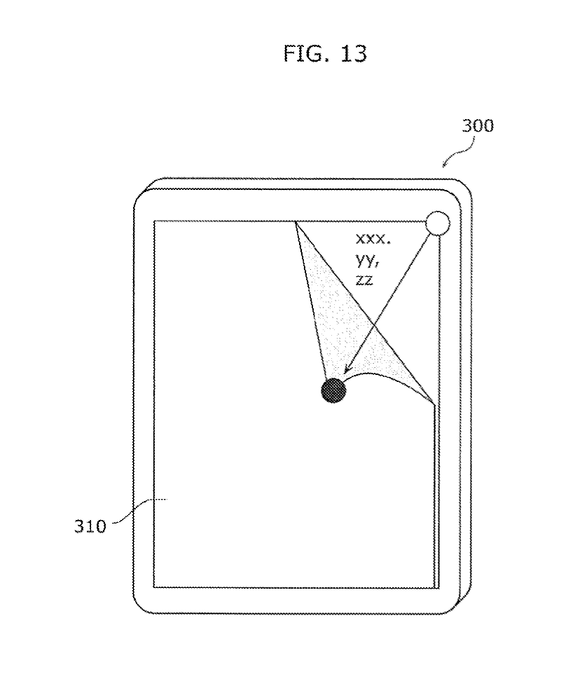

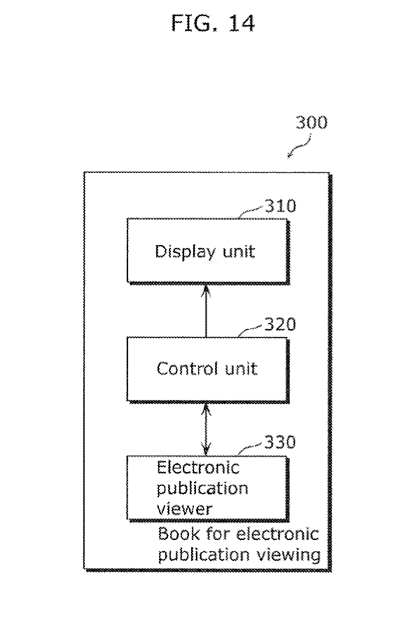

Next, with reference to FIG. 13 and FIG. 14, an electronic publication viewer according to Embodiment 2 of the present invention will be described. Detailed description of similarities to Embodiment 1 will be omitted, and differences will be mainly described.

In Embodiment 1, the electronic publication viewer 100 is provided separately from the book for electronic publication viewing 201. In Embodiment 2, an electronic publication viewer 330 is integrally formed with a book for electronic publication viewing 300. More specifically, the electronic publication viewer 330 is included in the book for electronic publication viewing 300.

The book for electronic publication viewing 300 according to Embodiment 2 includes a display unit 310 on the surface thereof as shown in FIG. 13. The book for electronic publication viewing 300 according to Embodiment 2 includes the display unit 310, a control unit 320, and the electronic publication viewer 330 as shown in FIG. 14.

In Embodiment 1, the display image data is displayed on the display unit 113 provided in the lens of the head mounted display 11. Thereby, the user feels as if the display image data is displayed on the page of the book for electronic publication viewing 201 seen through the lens. Namely, actually, nothing is displayed on the page of the book for electronic publication viewing 201.

On the other hand, the display unit 310 according to Embodiment 2 corresponds to the page of the book for electronic publication viewing 300, and is the display surface on which the display image data is displayed. Namely, unlike Embodiment 1, in Embodiment 2, the display unit 310 is the page of the book for electronic publication viewing 300, and the display image data is actually displayed on the page.

The specific configuration of the display unit 310 is not particularly limited, and liquid crystal displays, plasma displays, organic EL (Electro Luminescence) displays, and the like can be used, for example.

Moreover, the book for electronic publication viewing 201 according to Embodiment 1 has a form of a book having a plurality of pages, and the page is switched by actually turning the page. On the other hand, unlike Embodiment 1, the book for electronic publication viewing 300 according to Embodiment 2 has no physical page, and the user performs a predetermined operation to switch a virtual page displayed on the display unit 310.

The control unit 320 switches the display target page to be displayed on the display unit 310 according to the operation by the user. For example, the display unit 310 is a touch sensor. The user touches an upper right end of the display unit 310 (position shown by a blank circle in FIG. 13) with a finger, and slides the finger on the display unit 310 along the arrow in FIG. 13 to the center of the display unit 310 (position shown by a solid circle in FIG. 13). At this time, the control unit 320 detects the position shown by the blank circle, the sliding operation in the arrow direction, and the position shown by the solid circle in FIG. 13, and controls the content to be displayed on the display unit 310 such that the upper right end of the page displayed immediately before the sliding operation is curled up to the position shown by the solid circle, and the next page is displayed on an exposed portion. Further, when the control unit 320 detects the user leaving the finger touching the position shown by the solid circle for a predetermined time, the control unit 320 continuously switches the page to be displayed in the upper right corner of the display unit 310 in FIG. 13 (the exposed portion in the page). Namely, an operation similar to an operation to flip through the pages in a physical book is expressed.

At this time, based on the detected position shown by the blank circle in FIG. 13, the sliding operation in the arrow direction, and the position shown by the solid circle, the control unit 320 specifies the detected display target page and the position and size of the display target region. The control unit 320 transmits the specified display target page and the position and size of the display target region to the electronic publication viewer 330, and obtains the display image data to be displayed on the display target region from the electronic publication viewer 330. Thereby, the display image data is displayed on the display unit 310.

The electronic publication viewer 330 may have a configuration shown in FIG. 1, for example, or may include the display region specifying unit 12, the storage unit 13, the user interaction unit 101, the title specifying unit 102, the page structure data obtaining unit 108, the rendering unit 110, the display control unit 111, and the like in FIG. 4. The display region specifying unit 12 in this case specifies the display target page and the position and size of the display target region based on the information from the control unit 320, as described above.

Thus, the present invention can also be used for the book for electronic publication viewing 300 in which the user performs an operation similar to the operation to turn the page on the display unit 310 that functions as a touch sensor, thereby to switch the page to be displayed on the display unit 310.

The present invention has been described according to the embodiments above, but the present invention will not be limited to the embodiments. The following cases are also included in the present invention.

The respective apparatuses are specifically a computer system including a microprocessor, a ROM, a RAM, a hard disk unit, a display unit, a keyboard, a mouse, and the like. A computer program is stored in the RAM or the hard disk unit. The microprocessor operates according to the computer program. Thereby, the respective apparatuses achieve the functions. Here, the computer program is composed of a combination of command codes indicating instructions to the computer in order to achieve predetermined functions.

Part or all of components that form the respective apparatuses may be composed of a single system LSI (Large Scale Integration: large scale integrated circuit). The system LSI is an ultra multifunctional LSI manufactured by integrating a plurality of components on a chip, and specifically is a computer system including a microprocessor, a ROM, and a RAM. A computer program is stored in the RAM. The microprocessor operates according to the computer program. Thereby, the system LSI achieves the function.

Part or all of components that form the respective apparatuses may be composed of an IC card or single module that can be detachably mounted on the respective apparatuses. The IC card or the module is a computer system including a microprocessor, a ROM, and a RAM. The IC card or the module may include the ultra multifunctional LSI above. The microprocessor operates according to the computer program. Thereby, the IC card or the module achieves the function. The IC card or the module may have tamper resistance.

The present invention may be the method shown above. Alternatively, the present invention may be a computer program for causing a computer to implement these methods, or may be digital signals composed of a computer program.

Alternatively, the present invention may be a computer program or digital signals recorded in a computer-readable recording medium such as a flexible disk, a hard disk, a CD-ROM, an MO, a DVD, a DVD-ROM, a DVD-RAM, a BD (Blu-ray Disc), and a semiconductor memory. Alternatively, the present invention may be digital signals recorded in these recording media.

Alternatively, the present invention may be a computer program or digital signals transmitted via an electric communication line, a wireless or wired communication line, a network such as the Internet, and data broadcasting.

Alternatively, the present invention may be a computer system including a microprocessor and a memory; the memory stores the computer program above, and the microprocessor operates according to the computer program.

Alternatively, a program or digital signals may be recorded in a recording medium and transported, or may be transmitted via a network to implement the present invention by other independent computer system.

The embodiments and modifications above may be combined.

As above, the embodiments according to the present invention have been described with reference to the drawings, but the present invention will not be limited to the embodiments Shown. Various modifications and changes can be made to the embodiments shown within the scope of the present invention or within the scope of equivalents.

### INDUSTRIAL APPLICABILITY

The present invention can be used as a high speed display unit in an electronic publication viewer in which a content of an electronic publication is superimposed and displayed on a display surface.

### REFERENCE SIGNS LIST

11 Head mounted display
12 Display region specifying unit
13 Storage unit
100, 330, 1000 Electronic publication viewer
101 User interaction unit
102 Title specifying unit
103 Camera
104 Image obtaining unit
105 Marker recognizing unit
106 Display target page specifying unit
107 Page shape specifying unit
108, 1200 Page structure data obtaining unit
109 Page structure data caching unit
110, 1300 Rendering unit
111, 1500 Display control unit
112, 1400 Display image data caching unit
113, 310 Display unit
201, 300 Book for electronic publication viewing
201a Marker
320 Control unit
1100 Display target specifying unit

1. An electronic publication viewer that displays each page of an electronic publication on a display surface such that the page of the electronic publication is superimposed on a corresponding page of a book for electronic publication viewing, said electronic publication viewer comprising:
a display target specifying unit configured to specify a display target page including a display target region which is a portion of the page in the book for electronic publication viewing seen through the display surface by a user, and a position and size of the display target region in the display target page;
a page structure data obtaining unit configured to obtain page structure data corresponding to the display target page, the page structure data defining a content of each page in the electronic publication to be displayed;
a rendering unit configured to generate display image data corresponding to the position and size of the display target region specified by said display target specifying unit from the page structure data obtained by said page structure data obtaining unit, the display image data being image data to be displayed on the display surface;
a display image data caching unit configured to cache the display image data generated by said rendering unit; and
a display control unit configured to cause the display image data obtained from said display image data caching unit to be displayed in the position on the display surface superimposed on the display target region when the display image data corresponding to the display target region is cached in said display image data caching unit, and
to cause said rendering unit to newly generate the display image data, and the display image data newly generated by said rendering unit to be displayed in the position on the display surface superimposed on the display target region when the display image data corresponding to the display target region is not cached in said display image data caching unit.

2. The electronic publication viewer according to claim 1,
wherein said display control unit is configured to extract only a portion corresponding to the display target region from the display image data and cause the portion to be displayed on the display surface, and cache the extracted display image data in said display image data caching unit when the display image data on the display target page cached in said display image data caching unit includes a corresponding display target region.

3. The electronic publication viewer according to claim 2,
wherein said display control unit is further configured to extract only a portion corresponding to the display target region and cache the extracted display image data in said display image data caching unit with respect to display image data different from the display target page cached in said display image data caching unit.

4. The electronic publication viewer according to claim 1,
wherein said display control unit is configured to cause said rendering unit to generate only the display image data which corresponds to a portion of the display target region and is not included in the display image data caching unit,
combine the display image data cached in said display image data caching unit with the display image data newly generated by said rendering unit and cause the combined display image data to be displayed on the display surface, and cache the combined display image data in said display image data caching unit when the display image data cached in said display image data caching unit does not include the portion of the display target region.

5. The electronic publication viewer according to claim 1, further comprising a page structure data caching unit configured to cache the page structure data,
wherein said page structure data obtaining unit is configured to
obtain the page structure data from said page structure data caching unit when the page structure data corresponding to the display target page is cached in said page structure data caching unit, and
obtain the page structure data from an external apparatus connected via a communication network, and cache the obtained page structure data in said page structure data caching unit when the page structure data corresponding to the display target page is not cached in said page structure data caching unit.

6. The electronic publication viewer according to claim 5,
wherein said page structure data obtaining unit is configured to obtain the page structure data on a plurality of pages including the display target page from the external apparatus at the same time, and increase or decrease the number of the pages included in the page structure data to be obtained at the same time according to an area of the display target region specified by said display target specifying unit.

7. The electronic publication viewer according to claim 1, further comprising:
a user interaction unit configured to receive an instruction from the user; and
a title specifying unit configured to specify title information for indentifying the electronic publication to be displayed for the user among a plurality of the electronic publications, based on the instruction received by said user interaction unit.

8. The electronic publication viewer according to claim 1, said electronic publication viewer further comprising a head mounted display comprising the display surface to be disposed in a position facing an eye of the user, and an image capturing unit configured to capture the display target region,
wherein based on an image captured by said image capturing unit, said display target specifying unit is configured to specify the display target page including the display target region, and the position and size of the display target region in the display target page.

9. The electronic publication viewer according to claim 8,
wherein the book for electronic publication viewing includes a plurality of pages and a plurality of markers disposed in each of the pages, each of the markers including page information for indentifying the page, and position information indicating a position in the page, and
said display target specifying unit is configured to specify a display target page including the display target region and the position and size of the display target region in the display target page, based on the page information and the position information of the marker included in the display target region captured by said image capturing unit.

10. The electronic publication viewer according to claim 9,
wherein said display target specifying unit is further configured to specify an amount of the display target region to be deformed, based on a difference between a position of the marker in the display target page specified by the information indicating the position and an actual position of the marker in the display target page captured by said image capturing unit, and
said display control unit is configured to deform the display image data based on the amount of the display target region to be deformed specified by said display target specifying unit, and cause the deformed display image data to be displayed on the display surface.

11. The electronic publication viewer according to claim 1,
wherein the book for electronic publication viewing includes the display surface and a control unit configured to switch the display target page to be displayed on the display surface according to an operation by the user, and
said display target specifying unit is configured to obtain the display target page including the display target region and the position and size of the display target region in the display target page from said control unit to display the display target page.

12. A method for viewing an electronic publication wherein each page of the electronic publication is displayed on a display surface such that the page of the electronic publication is superimposed on a corresponding page in a book for electronic publication viewing, said method comprising:
specifying a display target page including a display target region which is a portion of the page in the book for electronic publication viewing seen through the display surface by a user, and a position and size of the display target region in the display target page;
obtaining page structure data corresponding to the display target page, the page structure data defining a content of each page in the electronic publication to be displayed;
generating display image data corresponding to the position and size of the display target region specified in said specifying from the page structure data obtained in said obtaining, the display image data being image data to be displayed on the display surface; and
causing the display image data obtained in caching the display image data generated to be displayed in the position on the display surface superimposed on the display target region when the display image data corresponding to the display target region is cached in said caching, and
newly generating the display image data, and causing the display image data newly generated to be displayed in the position on the display surface superimposed on the display target region when the display image data corresponding to the display target region is not cached in said caching.

13. A non-transitory computer readable recording medium having a program for a computer recorded, the program for causing a computer to display each page of an electronic publication on a display surface such that the page of the electronic publication is superimposed on a corresponding page of a book for electronic publication viewing, said program causing a computer to execute:
specifying a display target page including a display target region which is a portion of the page in the book for electronic publication viewing seen through the display surface by a user, and a position and size of the display target region in the display target page;
obtaining page structure data corresponding to the display target page, the page structure data defining a content of each page in the electronic publication to be displayed;
generating display image data corresponding to the position and size of the display target region specified in said specifying from the page structure data obtained in said obtaining, the display image data being image data to be displayed on the display surface; and
causing the display image data obtained in caching the display image data generated to be displayed in the position on the display surface superimposed on the display target region when the display image data corresponding to the display target region is cached in said caching, and
newly generating the display image data, and causing the display image data newly generated to be displayed in the position on the display surface superimposed on the display target region when the display image data corresponding to the display target region is not cached in said caching.

14. An integrated circuit that displays each page of an electronic publication on a display surface such that the page of the electronic publication is superimposed on a corresponding page in a book for electronic publication viewing, said integrated circuit comprising:
a display target specifying unit configured to specify a display target page including a display target region which is a portion of the page in the book for electronic publication viewing seen through the display surface by a user, and a position and size of the display target region in the display target page;
a page structure data obtaining unit configured to obtain page structure data corresponding to the display target page, the page structure data defining a content of each page in the electronic publication to be displayed;
a rendering unit configured to generate display image data corresponding to the position and size of the display target region specified by said display target specifying unit from the page structure data obtained by said page structure data obtaining unit, the display image data being image data to be displayed on the display surface,
a display image data caching unit configured to cache the display image data generated by said rendering unit; and
a display control unit configured to cause the display image data obtained from said display image data caching unit to be displayed in the position on the display surface superimposed on the display target region when the display image data corresponding to the display target region is cached in said display image data caching unit, and
to cause said rendering unit to newly generate the display image data, and the display image data newly generated by said rendering unit to be displayed in the position on the display surface superimposed on the display target region when the display image data corresponding to the display target region is not cached in said display image data caching unit.
